(19) United States
(12) Patent Application Publication
(10) Pub. No.: US 2009/0026798 A1
(43) Pub. Date: Jan. 29, 2009

(54) PEDESTRIAN PROTECTION APPARATUS FOR FRONT END OF VEHICLE

(76) Inventor: Chang Young Lee, Seongnam-si (KR)

Correspondence Address: MORGAN, LEWIS & BOCKIUS LLP (SF), One Market, Spear Street Tower, Suite 2800, San Francisco, CA, 94105, US

(21) Appl. No.: 11/942,869

(22) Filed: Nov. 20, 2007

(30) Foreign Application Priority Data
Jul. 27, 2007 (KR) 10-2007-0075944

(51) Int. Cl. B60R 21/34

(52) U.S. Cl. 296/187.04

(57) ABSTRACT

A pedestrian protection apparatus for use in an upper frame of a front end module of a vehicle. The apparatus includes a mounting part fastened to the upper frame, a shock absorbing part extending from the mounting part towards the front end of the vehicle, and a plurality of ribs extending between the mounting part and the shock absorbing part. The front end of the shock absorbing part may extend towards the boundary between the hood and the bumper of the vehicle. The front end of the shock absorbing part may extend about 15-20 mm beyond the front ends of the ribs, towards the front end of the vehicle. Each of the ribs may have a concave surface between the mounting part and the shock absorbing part.

### CROSS-REFERENCE TO RELATED APPLICATIONS

This application claims priority to Korean Application No. 10-2007-0075944, filed on Jul. 27, 2007, the disclosure of which is incorporated herein by reference.

### BACKGROUND OF THE INVENTION

1. Field of the Invention

The present invention relates to a pedestrian protection apparatus provided in a front end of a vehicle to protect the upper leg of a pedestrian in a collision with the front end of the vehicle.

2. Description of the Related Art

Vehicle-pedestrian accidents severely threaten the lives of pedestrians. Most countries have implemented regulations for pedestrian safety and vehicle makers have provided various shock absorbing devices in the front ends of vehicles to protect pedestrians.

Meanwhile, the upper leg of the pedestrian may collide against the boundary between the hood and the bumper in a vehicle-pedestrian accident. In this instance, since a front end module is spaced apart from the boundary, the boundary part of the hood is rapidly crumpled, and thus a relatively large shock is applied from the front end module to the upper leg of the pedestrian.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A pedestrian protection apparatus for use in an upper frame of a front end module of a vehicle. The apparatus includes a mounting part fastened to the upper frame, a shock absorbing part extending from the mounting part towards the front end of the vehicle, and a plurality of extending between the mounting part and the shock absorbing part.

The front end of the shock absorbing part may extend towards the boundary between the hood and the bumper of the vehicle.

The front end of the shock absorbing part may extend about 15-20 mm beyond the front ends of the ribs, towards the front end of the vehicle.

Each of the ribs may have a concave surface between the mounting part and the shock absorbing part.

Meanwhile, it is preferable that the pedestrian protection apparatus be made of plastic, mainly polypropylene to increase the shock absorption ability thereof.

### BRIEF DESCRIPTION OF THE DRAWINGS

The above and other features of the present invention will now be described in detail with reference to certain exemplary embodiments thereof illustrated the accompanying drawings, which are given by way of illustration only, and thus are not limitative of the present invention, and wherein:

FIG. 1 is a perspective view of a front end module including a pedestrian protection structure of an embodiment of the present invention;

FIG. 2 is a perspective view of the pedestrian protection structure of FIG. 1;

FIG. 3 is a sectional view taken along the line A-A′ of FIG. 1; and

FIG. 4 is an enlarged partial view of FIG. 3.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF THE PREFERRED EMBODIMENTS

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

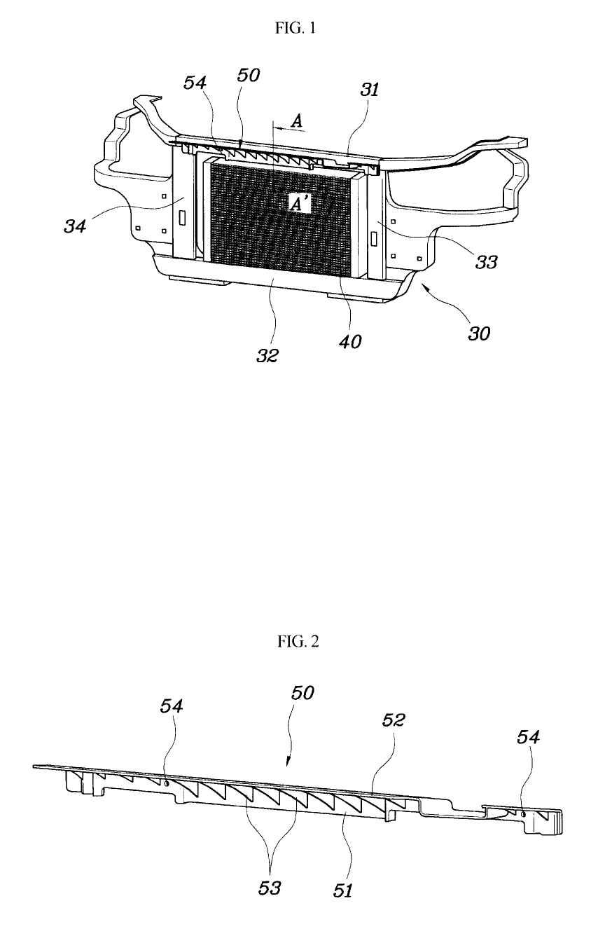

Referring to FIG. 1, a front end module 30 includes various elements, such as a radiator 40, headlamps (not shown), a horn, etc., are integrated with each other in a single frame. Typically, this frame is called a carrier or a bolster. The frame of the front end module 30 includes upper and lower frames 31 and 32 and left and right frames 33 and 34. The radiator 40 is installed at the center between the frames 31, 32, 33 and 34.

Referring also to FIGS. 2-4, a shock absorption member 50 is mounted to the upper frame 31. The shock absorption member 50 includes a mounting part 51, a shock absorbing part 52, and ribs 53. Referring to FIG. 4, the mounting part 51 and the shock absorbing part 52 have an “L”-shaped angled structure, and may be made of plastic or any other suitable material.

The mounting part 51, through which the shock absorption member 50 is fastened to the upper frame 31, is in surface contact with the upper frame 31. Furthermore, a plurality of bolt holes 54 for bolting the mounting part 51 to the upper frame 31 is formed through the mounting part 51 in the longitudinal direction.

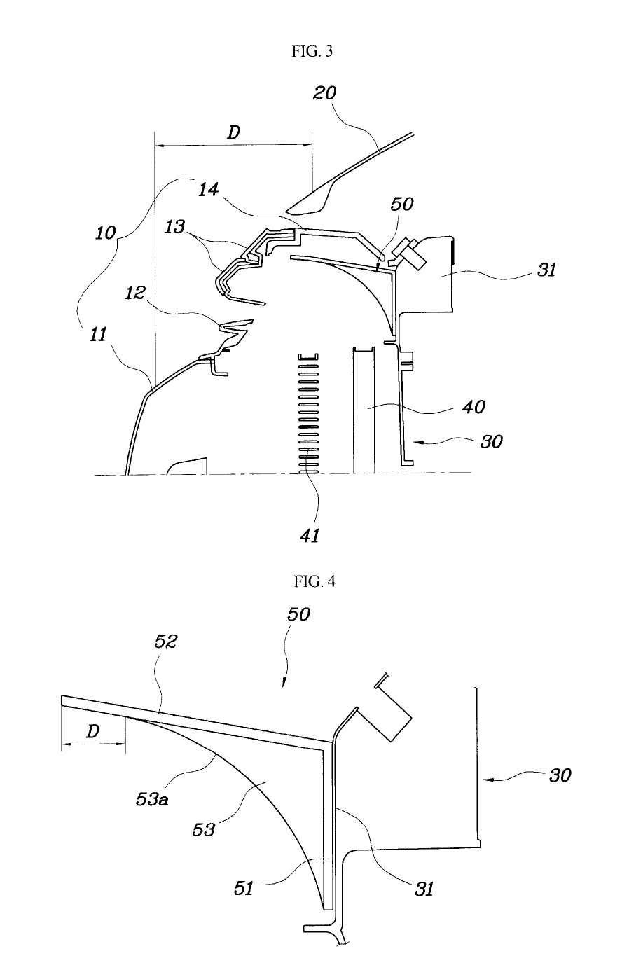

The shock absorbing part 52 is angle with respect to the upper end of the mounting part 51 and extends towards the front end¹¹⁸ of the vehicle, in particular, towards the boundary between a hood 20 and a bumper 11 of the vehicle (FIG. 3). The shock absorbing part 52 is in such a way as to protect the upper leg of a pedestrian that collides with the vehicle at an angle of approximately 40° relative to the horizontal plane. The shock absorbing part 52 withstands shocks in the initial stage and is gradually bent, thus absorbing the shock energy. The shock absorbing part 52 may alternatively extend from the lower end of the mounting part 51 towards the front end of the vehicle. In this case, the shock absorbing part 52 is mounted to the upper frame 31 in an orientation that can be visualized by turning FIG. 4 upside down.

A bumper assembly 10 is provided ahead of the shock absorbing part 52. The bumper assembly 10 includes, from the bottom to the top: the bumper 11; a radiator grill 12; an extension panel 13;¹⁴³ and an upper cover 14, which covers the front end module 30. The bumper assembly 10 can also be called a front end panel. The hood 20 is disposed above the upper cover 14. The radiator 40 and a condenser 41 are disposed below the shock absorption member 50.

The ribs 53 are provided between the mounting part 51 and the shock absorbing part 52 to increase the strength of the shock absorption member 50 in the longitudinal direction of the vehicle. Several ribs 53 are provided at regular intervals along the shock absorption member 50.

Referring to FIG. 4, each rib 53 has a concave surface 53a, such that when a shock is applied to the front end of the vehicle in a rearward direction, the shock absorbing part 52 is bent towards the mounting part 51. The rib 52 extends downward and inward to the lower end of the mounting part 51. Preferably, the frontmost part D of the shock absorbing part 52, in which the rib 53 is not formed, has a length ranging from 15 mm to 20 mm in consideration of shock characteristics. When a shock is applied, in the initial stage, the front end part D withstands the shock energy using its elastic force, and, thereafter, is bent towards the mounting part 51.

As described above, a pedestrian protection structure of the front end of a vehicle according to the present invention can markedly reduce shocks applied to the upper leg of a pedestrian when a vehicle-pedestrian accident occurs.

Although a preferred embodiment of the present invention has been disclosed for illustrative purposes, those skilled in the art will appreciate that various modifications, additions and substitutions are possible, without departing from the scope and spirit of the invention as defined in the accompanying claims.

What is claimed is:

1. A pedestrian protection apparatus for use in an upper frame of a front end module of a vehicle, the apparatus comprising:
a mounting part configured to be fastened to the upper frame;
a shock absorbing part extending from the mounting part towards a front end of the vehicle; and
a plurality of ribs extending between the mounting part and the shock absorbing part.

2. The apparatus as set forth in claim 1, wherein a front end of the shock absorbing part extends towards a boundary between a hood and a bumper of the vehicle.

3. The as set forth in claim 1, wherein a front end of the shock absorbing part extends beyond front ends of the ribs towards the front end of the vehicle.

4. The apparatus as set forth in claim 3, wherein the front end of the shock absorbing part extends about 15-20 mm beyond the front ends of the ribs.

5. The apparatus as set forth in claim 1, wherein each of the ribs comprises a concave surface between the mounting part and the shock absorbing part.
